(19) United States
(12) Patent Application Publication
(10) Pub. No.: US 2019/0079996 A1
(43) Pub. Date: Mar. 14, 2019

(54) COLLABORATIVE ANALYTIC ECOSYSTEM

(71) Applicant: General Electric Company, Schenectady, NY (US)

(72) Inventors: Karl Lewis MOCHEL, San Francisco, CA (US); Fuxiao XIN, San Diego, CA (US); Jeng-Weei LIN, San Ramon, CA (US); Kareem Sherif AGGOUR, Niskayuna, NY (US); Alexander K. CARROLL, Lopez Island, WA (US)

(21) Appl. No.: 15/699,524

(22) Filed: Sep. 8, 2017

(51) Int. Cl. G06F 17/30

(52) U.S. Cl. CPC G06F 17/30651; G06F 17/30554; G06F 17/30716; G06F 17/30126; G06F 17/30601

(57) ABSTRACT

According to some embodiments, system and methods are provided, comprising a collaboration analytic module; a display; a memory storing processor-executable process steps; and a collaboration analytic processor coupled to the memory, and in communication with the collaboration analytic module and operative to execute the processor-executable process steps to cause the system to: initiate a collaboration session; receive input at the collaboration session, wherein the collaboration session is integrated with a source of the received input; generate a visualization based on the received input; receive selection from a user of at least one collaborator to participate in the collaboration session; present the visualization on the display, wherein the visualization is viewable by the user and at least one collaborator; receive a manipulation of the visualization; record the manipulation of the visualization; and associate the recorded manipulation with a manipulation source. Numerous other aspects are provided.

### BACKGROUND

An ecosystem is a network of interconnected and interdependent entities. An analytic ecosystem may contain interacting elements. For example, individuals and groups—business and technical teams with multiple skillsets, business partners and customers, internal and external data, tools, software and infrastructure may form the analytic ecosystem. Analytic ecosystems may include the use of IoT, Database technologies, Teradata (an analytic framework and platform), Big Data platforms such as Apache Hadoop and/or Apache Spark, file systems, data warehouse, and microservices. Further, an organization can be viewed within a larger analytic ecosystem that consists of other organizations and entities sharing and exchanging data. The analytic ecosystem may include data, which may be integrated from multiple sources, different types of analysis and skills to generate insights, and users to act on the generated insights.

Current analytic ecosystems only allow users to share results or objects in the system, such as data, models and prediction runs, but not the work itself, where “work” refers to the process and steps the user went through to transform the raw input data into the final results, such as a prediction or output model. For example, the originator of the outcome often has to recast their work in a static medium to share it with others. Then, the people who receive these results have to set up the problem in their own environments, sometimes making significantly different decisions about using the data, models and outcomes.

It would be desirable to provide systems and methods to improve the operation of and sharing within an analytic ecosystem.

### BRIEF DESCRIPTION

According to some embodiments, a system includes a collaboration analytic module; a display; a memory storing processor-executable process steps; and a collaboration analytic processor coupled to the memory, and in communication with the collaboration analytic module and operative to execute the processor-executable process steps to cause the system to: initiate a collaboration session; receive input at the collaboration session, wherein the collaboration session is integrated with a source of the received input; generate a visualization based on the received input; receive selection from a user of at least one collaborator to participate in the collaboration session; present the visualization on the display, wherein the visualization is viewable by the user and at least one collaborator; receive a manipulation of the visualization; record the manipulation of the visualization; and associate the recorded manipulation with a manipulation source.

According to some embodiments, a computer implemented method includes initiating a collaboration session; receiving input at the collaboration session, wherein the collaboration session is integrated with a source of the received input; generating a visualization based on the received input; receiving selection from a user of at least one collaborator to participate in the collaboration session; presenting the visualization on the display, wherein the visualization is viewable by the user and at least one collaborator; receiving a manipulation of the visualization; recording the manipulation of the visualization; and associating the recorded manipulation with a manipulation source.

According to some embodiments, a non-transitory, computer-readable medium storing instructions that, when executed by a computer processor, cause the computer processor to: initiate a collaboration session; receive input at the collaboration session, wherein the collaboration session is integrated with a source of the received input; generate a visualization based on the received input; receive selection from a user of at least one collaborator to participate in the collaboration session; present the data in a visualization on the display, wherein the visualization is viewable by the user and at least one collaborator; receive a manipulation of the visualization; record the manipulation of the visualization; and associate the recorded manipulation with a manipulation source.

With this and other advantages and features that will become hereinafter apparent, a more complete understanding of the nature of the invention can be obtained by referring to the following detailed description and to the drawings appended hereto.

Other embodiments are associated with systems and/or computer-readable medium storing instructions to perform any of the methods described herein.

### DRAWINGS

FIG. 1 illustrates a system according to some embodiments.

FIG. 2 illustrates a flow diagram according to some embodiments.

FIG. 3 illustrates a user interface according to some embodiments.

FIG. 4 illustrates a user interface according to some embodiments.

FIG. 5 illustrates a user interface according to some embodiments.

FIG. 6 illustrates a block diagram of a system according to some embodiments.

FIG. 7 illustrates a block diagram according to some embodiments.

### DETAILED DESCRIPTION

Industrial equipment or assets, generally, are engineered to perform particular tasks as part of a business process. For example, industrial assets can include, among other things and without limitation, manufacturing equipment on a production line, wind turbines that generate electricity on a wind farm, healthcare or imaging devices (e.g., X-ray or MRI systems) for use in patient care facilities, or drilling equipment for use in mining operations. The design and implementation of these assets often takes into account both the physics of the task at hand, as well as the environment in which such assets are configured to operate.

Assets, including the asset components, typically acquire damage during assigned operations. For industries, a challenge is assessing a health status (e.g., state of damage) of an asset at a one or more points in time, and then scheduling appropriate maintenance or dynamically changing the duty assignment or maintenance to avoid unexpected failures or reduction in operational utility. Conventionally, a mix of sensors and analytics in condition-based and predictive maintenance programs provide a simple threshold level for a specific asset such as an engine component.

Data scientists leverage different modeling techniques to build these analytic models that make predictions from data (e.g., real or simulated). Typically, there are several pre-processing steps applied to raw data before models are applied to the data.

In one or more embodiments, a collaborative analytic ecosystem (CAE) is provided that combines two sets of tools. The first set is analytic tools to find data, clean data, create analytic models, validate analytic models, and visualize any point in the analytic process. The second set is conversation tools to provide for discussing the data, processing and analytics and programming code. As used herein, a model is an output of an analytic, and the “analytic” is the whole pipeline that leads to the model. As used herein, the terms “analytic model,” and “model” may be used interchangeably.

Conventionally, these tools are separate and a first user may generate a static snapshot of data and converse about the snapshot with others. However, since this data is not live, if another user views the data and says “I don't actually think this is what's happening here, I want to view it differently, or change parameters, etc.,” for example, with the conventional system, the first user may have to leave the conversation, re-run the analysis, make a static copy of it, and then load the static copy into the conversation. This may result in longer, more complicated discussions with a greater likelihood of miscommunication and misunderstanding of what the analytic actually did.

Embodiments provide for the interactive pairing of these two tool sets where users and/or Artificial Intelligence (AI) agents may see the current state of the analytic, look at the history of the analytic development process and comment on any aspect in the context of the analytic. In one or more embodiments, the combined analytic and conversation tools allow users to involve other users or AI agents in the process of creating and validating analytics. By sharing the environment and providing contextual conversation, embodiments may make it easier for participants to share their work (e.g., end results, as well as the intermediate results and best practices and questions raised during the process) and what direction to continue in. Benefits include a reduction in the effort needed when working with groups, and an increase in participant understanding of each other's individual and group process and mental models.

As a consequence, there may be new opportunities to enhance the operational value of some industrial asset using novel industrial-focused hardware and software. One or more embodiments provide an integrated system that provides for the combination of analytic tools and conversation tools and the results of a collaboration session may be used to control the physical state of the asset and the processes which use it/them through time.

A technical effect of some embodiments of the invention is an improved and/or computerized technique and system for a Collaborative Analytics Ecosystem (CAE). Embodiments provide for a CAE architecture that may combine tools for creating analytics and tools for conversing with either other people or artificial intelligence agents or systems. Embodiments provide for the performance and validation of analytic activities in an environment that tightly couples the data science/analytics activities of inputting, selecting, cleaning, and feature engineering data, selecting or writing models, and validating results technically and for business outcomes with sharing, conversing and the exploration of the process. Embodiments provide for a user to share a project so that other users may enter the collaboration space. The shared project may provide users a view of a history of the analytic process and an ability to comment on inflection points and/or suggest different directions for the process. For example, embodiments provide a user with the ability to see what part of a process or what areas of a process other users are viewing in a visualization. In one or more embodiments, users may manipulate the visualization, and provide instant chatting/feedback about the visualization. In one or more embodiments, manipulation of the visualization may include updating settings, preferences and parameters associated with an input. When the input is code or a model, one or more embodiments may provide for a user and one or more collaborators to jointly code or edit the code and/or model.

One or more embodiments provide the ability to capture a state of a system so that a conversation may be conducted about a particular state of activities while the analytics work continues. For example, users may select an element (e.g., fields, regions of a display, rows of tables, etc.) in the analytics experience to be the object of the conversation, in one or more embodiments. Then, in embodiments, a user or an artificial intelligence aspect of the system may highlight same parts of the analytics experience to bring attention to those parts. In a non-exhaustive example, there may be different visualizations of the same data. When a subset of the data is selected, the user or the artificial intelligence aspect may highlight that selected subset in all of the different visualizations. By sharing the environment and providing contextual conversations, the system may make it easier for participants to share the state of their work, how they reached the current state and what direction to continue in. Embodiments may reduce effort when working with groups and may increase participants understanding of each other's individual and group processes and mental models. Another technical effect of one or more embodiments is an increased throughput of analytics with reductions in time to creation, validation and implementation. The inventors note that by reducing the friction to gain agreement on appropriateness of data handling, outcomes benefits, error rates in context of outcomes, and deployment capture, via the interaction of the analytics and conversation aspects of one or more embodiments; there may be an increase in a team's ability to deploy more appropriate, useful, accurate and performant analytics. Still another technical effect of one or more embodiments is the provision of an environment that may be generic, diverse and complementary. The environment may provide re-usability, coverage and completeness, which may enable fast implementation and quick time-to-value.

Some embodiments relate to digital twin modeling. “Digital twin” state estimation modeling of industrial apparatus and/or other mechanically operational entities may estimate an optimal operating condition, remaining useful life, operating performance such as heart rate or other metric, of a twinned physical system using sensors, communications, modeling, history and computation. It may provide an answer in a time frame that is useful, that is, meaningfully prior to an occurrence of a failure event or suboptimal operation. The information may be provided by a “digital twin” of a twinned physical system. The digital twin may be a computer model that virtually represents the state of an installed product. The digital twin may include a code object with parameters and dimensions of its physical twin's parameters and dimensions that provide measured values, and keeps the values of those parameters and dimensions current by receiving and updating values via outputs from sensors embedded in the physical twin. The digital twin may have respective virtual components that correspond to essentially all physical and operational components of the installed product and combinations of products or assets that comprise an operation.

As used herein, references to a “digital twin” should be understood to represent one example of a number of different types of modeling that may be performed in accordance with teachings of this disclosure.

The term “installed product” should be understood to include any sort of mechanically operational entity, including, but not limited to, jet engines, locomotives, gas turbines, surgical and medical equipment, and wind farms and their auxiliary systems as incorporated. The term is most usefully applied to large complex systems with many moving parts, numerous sensors and controls installed in the system. The term “installed” includes integration into physical operations such as the use of engines in an aircraft fleet whose operations are dynamically controlled, a locomotive in connection with railroad operations, or apparatus construction in, or as part of, an operating plant building, machines in a factory or supply chain, etc.

As used herein, the term “automatically” may refer to, for example, actions that may be performed with little or no human interaction.

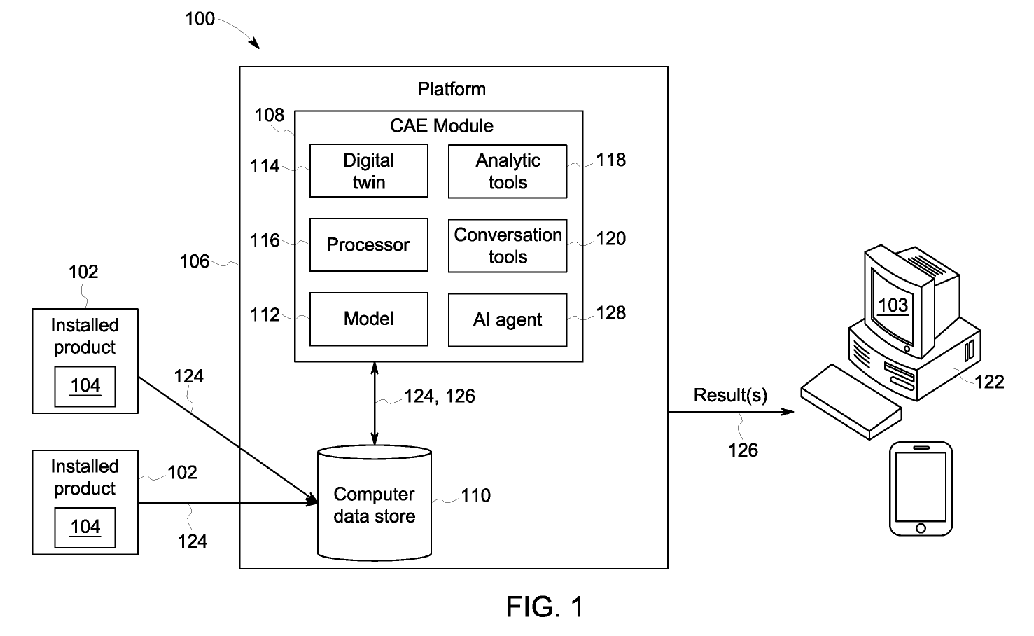

FIG. 1 is a block diagram of an example operating environment or system 100 in which a CAE module 108 may be implemented, arranged in accordance with at least one embodiment described herein. FIG. 1 represents a logical architecture for describing processes according to some embodiments, and actual implementations may include more or different components arranged in other manners.

The system 100 may include at least one “installed product” 102. While two installed products 102 are shown herein to represent a fleet of installed products 102, any suitable number may be used. It is noted that each installed product 102 communicates with a platform 106, and elements thereof, in a same manner, as described below. As noted above, the installed product 102 may be, in various embodiments, a complex mechanical entity such as the production line of a factory, a gas-fired electrical generating plant, a jet engine on an aircraft amongst a fleet (e.g., two or more aircrafts or other assets), a wind farm, a locomotive, etc. As used herein, the terms “installed product” and “asset” may be used interchangeably. The installed product 102 may include a considerable (or even very large) number of physical elements or components 104, which for example may include turbine blades, fasteners, rotors, bearings, support members, housings, etc. As used herein, the terms “physical element” and “component” may be used interchangeably. The installed product 102 may also include subsystems, such as sensing and localized control, in one or more embodiments.

In some embodiments, the platform 106 may include a computer data store 110 that may provide information to the CAE module 108 and store results from the CAE module 108. The CAE module 108 may include a model 112, a digital twin 114, and one or more processing elements 116, analytic tools 118 and conversation tools 120.

The processor 116 may, for example, be a conventional microprocessor, and may operate to control the overall functioning of the CAE module 108. In one or more embodiments, the processor 116 may be programmed with a continuous or logistical model of industrial processes that use the one or more installed products 102.

In one or more embodiments, the data store 110 may comprise any combination of one or more of a hard disk drive, RAM (random access memory), ROM (read only memory), flash memory, etc. The data store 110 may store software that programs the processor 116 and the CAE module 108 to perform functionality as described herein.

The data store 110 may support multi-tenancy to separately support multiple unrelated clients by providing multiple logical database systems which are programmatically isolated from one another.

The data store 110 may comprise any one or more systems that store data that may be used by an analytic, a portion of an analytic, and/or the module. As used herein, “analytic” refers to any operation on data that produces some output. The data stored in data store 110 may be received from disparate hardware and software systems associated with the installed product 102, or otherwise, some of which are not inter-operational with one another. The systems may comprise a back-end data environment employed in a business, industrial, or personal context. The data may be pushed to data store 110 and/or provided in response to queries received therefrom.

The data may be included in a relational database, a multi-dimensional database, an eXtendable Markup Language (XML) document, and/or any other structured data storage system. The physical tables of data store 110 may be distributed among several relational databases, multi-dimensional databases, and/or other data sources. The data of data store 110 may be indexed and/or selectively replicated in an index.

The data store 110 may implement as an “in-memory” database, in which volatile (e.g., non-disk-based) storage (e.g., Random Access Memory) is used both for cache memory and for storing data during operation, and persistent storage (e.g., one or more fixed disks) is used for offline persistency of data and for maintenance of database snapshots. Alternatively, volatile storage may be used as cache memory for storing recently-used database data, while persistent storage stores data. In some embodiments, the data comprises one or more of conventional tabular data, row-based data stored in row format, column-based data stored in columnar format, time series data in a time series data store, and object-based data.

The CAE module 108, according to some embodiments, may access the data store 110 and utilize the analytic tools 118, conversation tool 120 and processing elements 116 to create a result that may be transmitted as a visualization 103 to a collaboration session 301 presented on at least one of various user platforms 122 or to other systems (not shown), as appropriate (e.g., for display to, and manipulation by, a user). In one or more embodiments, the results of the collaboration session may be used to operate the installed product, operate another system, or by input to another system.

In one or more embodiments, the CAE module 108 may be executed to receive a request to create a collaboration session, invite other users to the collaboration session, to receive input for use in the collaboration session (e.g., query the data store 110 for data used in the collaboration session and receive the data from data store 110; to perform any necessary manipulations on the input, such as calculations on the data,) to format the input for display in the visualization 103, and to return the formatted input as a visualization 103 to client system 122. As used herien, “input” may refer to at least one of data, an analytic model, program code, and any other suitable input that may be discussed during the collaboration session. As used herein, the term “visualization” refers to the input displayed on the display during the collaboration session that is the subject of the collaboration session.

A communication channel 124 may be included in the system 100 to supply input from at least one of the installed product 102 and the data store 110 to the CAE module 108.

In some embodiments, the system 100 may also include a communication channel 126 to supply output from the CAE module 108 to at least one of user platforms 122, or to other systems. In some embodiments, signals received by the user platform 122, may cause modification in the state or condition or another attribute of the installed product 102. The modification may occur after the collaboration.

As used herein, devices, including those associated with the system 100 and any other devices described herein, may exchange information and transfer input (“communication”) via any number of different systems, including one or more wide area networks (WANs) and/or local area networks (LANs) that enable devices in the system to communicate with each other. In some embodiments, communication may be via the Internet, including a global internetwork formed by logical and physical connections between multiple WANs and/or LANs. Alternately, or additionally, communication may be via one or more telephone networks, cellular networks, a fiber-optic network, a satellite network, an infrared network, a radio frequency network, any other type of network that may be used to transmit information between devices, and/or one or more wired and/or wireless networks such as, but not limited to Bluetooth access points, wireless access points, IP-based networks, or the like. Communication may also be via servers that enable one type of network to interface with another type of network. Moreover, communication between any of the depicted devices may proceed over any one or more currently or hereafter-known transmission protocols, such as Asynchronous Transfer Mode (ATM), Internet Protocol (IP), Hypertext Transfer Protocol (HTTP) and Wireless Application Protocol (WAP).

A user may access the system 100 via one of the user platforms 122 (a control system, a desktop computer, a laptop computer, a personal digital assistant, a tablet, a smartphone, etc.) to view the visualization 103 and information about and/or manage the installed product 102 in accordance with any of the embodiments described herein. According to one or more embodiments, the system 100 may execute program code of a software application for presenting interactive graphical user display interfaces to provide the collaboration session 122 and to allow interaction with the CAE module 108.

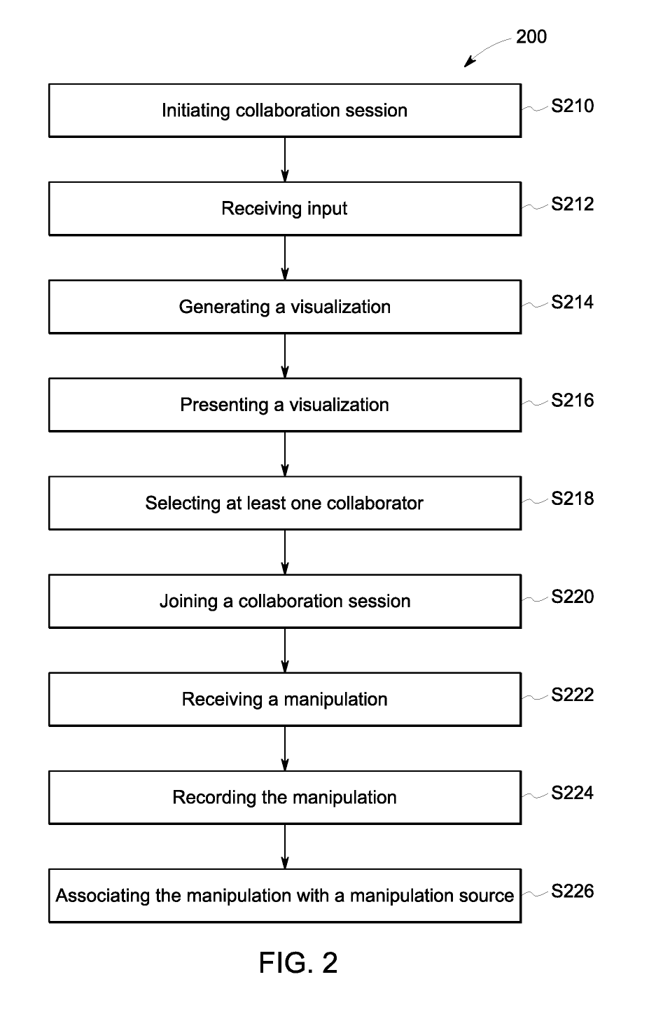

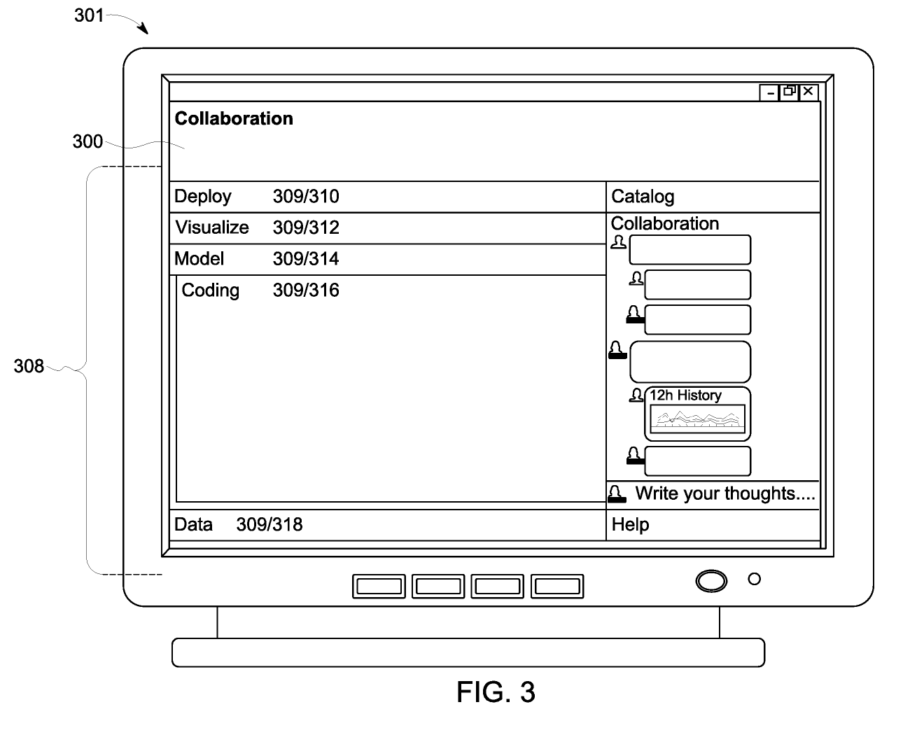

Turning to FIGS. 2-5, a flow diagram and associated user interface displays, of an example of operation according to some embodiments is provided. In particular, FIG. 3 provides a flow diagram of a process 200, according to some embodiments. Process 200, and any other process described herein, may be performed using any suitable combination of hardware (e.g., circuit(s)), software or manual means. For example, a computer-readable storage medium may store thereon instructions that when executed by a machine result in performance according to any of the embodiments described herein. In one or more embodiments, the system 100 is conditioned to perform the process 200 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto. The flow chart(s) described herein do not imply a fixed order to the steps, and embodiments of the present invention may be practiced in any order that is practicable.

Initially, at S210, a collaboration session 301 (FIG. 3) is initiated. In one or more embodiments, the collaboration session may be initiated by a first user 302 via access to a collaboration interface 300. As used herein, the “collaboration session” may refer to a period of time during which an aspect of visualized input is presented and discussed on the collaboration interface. The input that is visualized for the collaboration session may be referred to herein as a “project.” In one or more embodiments, the collaboration session may begin when the first user initiates the collaboration session, via access to the collaboration interface 300 and end at the end of the discussion. In one or more embodiments, the discussion may end by an end action of the first user 302, a collaborator, a specified time limit, or any other suitable end indicator. In one or more embodiments, the collaboration session may persist for an indefinite amount of time.

FIG. 3 is an outward view of the collaboration interface 300 presented on a display 304 according to some embodiments. More specifically, the CAE module 108 may execute process steps to provide the first user 302 with access to the collaboration session 301 via the collaboration interface 300.

As shown in FIG. 3, in one or more embodiments, the collaboration interface 300 may include a collaboration menu 308 having one or more selectable tabs 309. For example, a deploy tab 310, a visualize tab 312, a model tab 314, a coding tab 316 and a data tab 318. Any other suitable tabs may be used. In one or more embodiments, selection of the tab 309 may open a window to at least one of display and receive information associated with that selected tab. In one or more embodiments, the first user 302 may use at least one of the tabs 309 to initiate the collaboration session.

In one or more embodiments, selection of the deploy tab 310 may display a list of available analytic models for user selection. In one or more embodiments, the user may also select a running frequency and a running agent/server, and then submit the request to deploy the selected model.

Then in S212, input is received. In one or more embodiments, the input may be received from any suitable input source. For example, the input may be data received from sensors associated with the installed product 102, an analytic computing platform, sql and non-sql databases, or the user may have the option to upload data from a local drive. In one or more embodiments, the input may be a model received from an analytic computing platform, or programming code that generate all the results, or input directly by the first user. In one or more embodiments, the input may be natively coded in this environment, or uploaded here from another coding channel. In one or more embodiments, the collaboration session is integrated with the source of the input whereby the collaboration session includes the input and any manipulation performed on the input to generate a visualization, as described below. In one or more embodiments, the data may be used to at least one of perform and validate the analytic.

When the input is data, the data or data set may be accessed via the data tab 318. The first user 302 may select at least some portion of the data from the data tab 318 to portray in the visualization 103 for use in the collaboration session 301. In one or more embodiments, the first user 302 may select a portion of a larger data set to include in the data tab 318, instead of the entire data set. Prior to generation of the visualization, the first user 302 may apply the analytic to the selected data set, and then a visualization based on the output of this analytic may be generated. In one or more embodiments, any coding or models applied to the data during the generation of the visualization may be stored in the CAE module 108. As described above, in one or more embodiments, the input may be at least one of programming code and model(s). Whether the code and model(s) support the data, or the code and models are the subject of the collaboration session, the coding and models may be accessed via the coding tab 316 and model tab 314, respectively, during the collaboration session. In one or more embodiments, when the subject of the collaboration is code and/or models, the at least one of the code and model may be executed as part of the collaboration session to generate data. By including the data, code and models in the CAE module 108, and providing access to them during the collaboration session 108, collaborators/other users 304 may receive the visualization 103 with all of the components; the knowledge is retained by the project, and there is no need to set up the project on their own. The inventors note that a benefit of this contextually integrated collaboration is the ability for the first user to pass input to collaborators with minimal effort.

Next, the visualization 103 is generated in S214. In one or more embodiments, the visualization 103 may be a display of programming code, a model, a scatter plot, a data display, a histogram or density plot, or any other suitable graphic display of the input. The visualization 103 may be accessed during the collaboration session 301 via the visualize tab 312 of the collaboration interface 300. The visualization 103 may be presented on the collaboration interface 300 in S216.

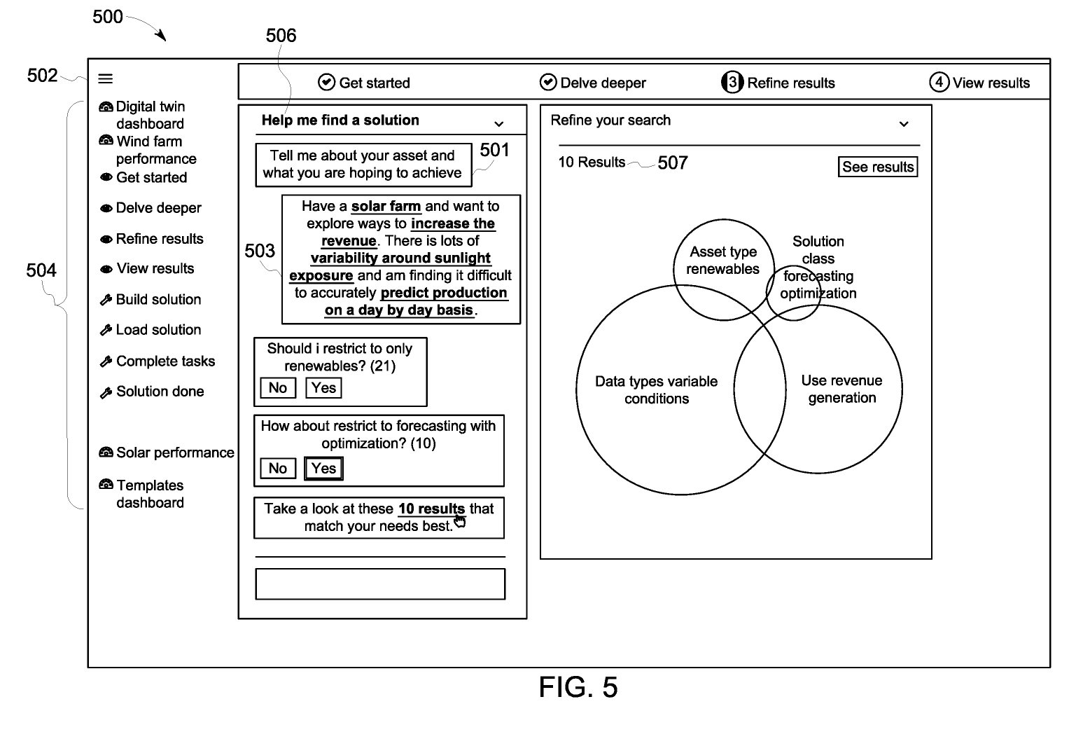

Then the first user 302 may select at least one collaborator/other user 304 to participate in the collaborations session in S218. In one or more embodiments, the collaboration interface 300 may also include a catalog 320 listing collaborators/other users 304 that may be invited to join the collaboration session. As used herein, the term “participants” may refer collectively to both the first user and other users/collaborator(s). In one or more embodiments, selection of the collaborator 304 may launch an email application associated with the system 100, with pre-filled send-to names/addresses, and some information related to the content of the collaboration session. For example, the content may include at least one of a link to the collaboration session and an image of the visualization. In one or more embodiments, the collaborator 304 viewing the email may click on the link or an attachment resulting in access to the collaboration session and interface 300. In one or more embodiments, the first user 302 may also add collaborators 304 to the catalog 320. In one or more embodiments, the CAE module 108 may suggest possible collaborators, as will be described further below with respect to FIG. 5. In some embodiments, the suggestion may be based on the input itself and/or a question posed by the first user 302 in relation to a given input.

When the collaborator 304 joins the collaboration session in S220, they may first be presented with the visualization 103. In one or more embodiments, the input and conversation aspects may be integrated so that the participants are all able to view the same live input.

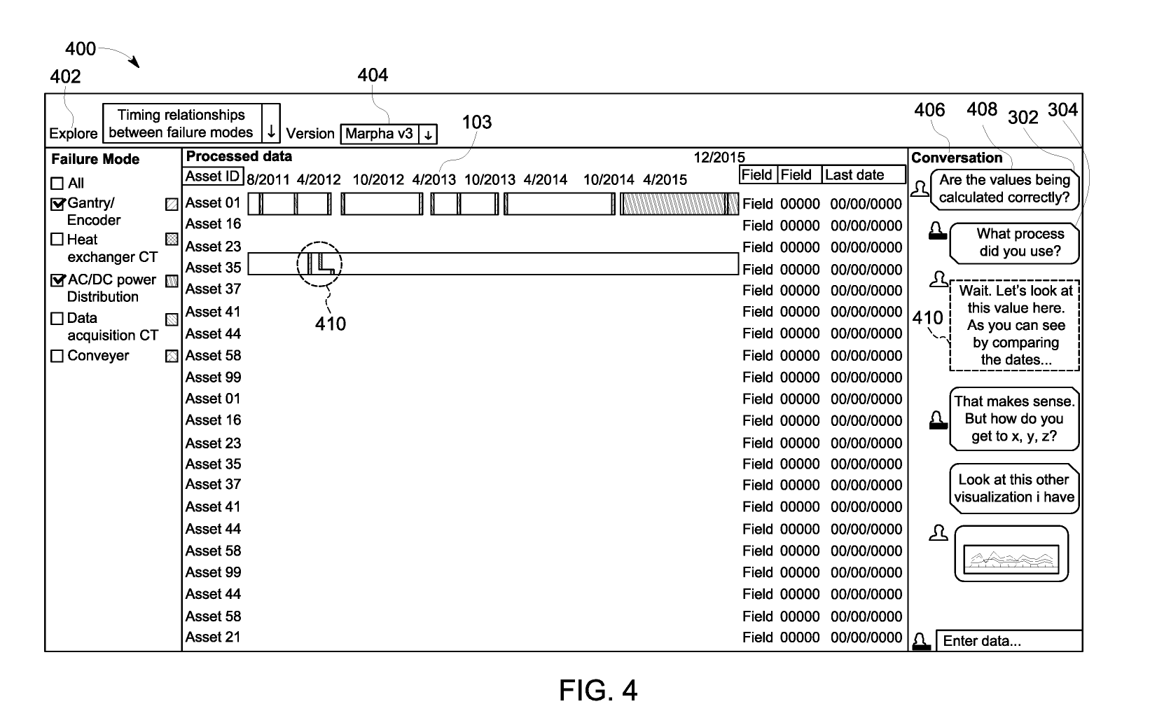

For example, FIG. 4 provides the visualization 103 on another window 400 of the collaboration interface 300. In this non-exhaustive example, the visualization 103 is a chart of processed data. In one or more embodiments, the collaboration interface 300 may include a description of the content and/or and exploration purpose 402 of the collaboration session. As shown herein, the exploration purpose 402 is to explore a “timing relationship between failure modes.” In one or more embodiments, one or more versions 404 of the visualization may be associated with the collaboration session 301. Continuing with the example, the visualization 103 shows one or more failure modes for multiple assets during different periods of time. In particular, the visualization 103 shows for Asset 01, a gantry/encoder failure mode was experienced near April 2012, and again in April 2013, October 2013 and October 2014.

In one or more embodiments, the collaboration interface 300 may include a conversation panel or frame 406. The conversation panel 406 may be a record of any comments and/or actions (referred to herein collectively as “manipulations”) taken by the first user 302 and collaborators 304 (“participants”) during the collaboration session. In one or more embodiments, the recordation may be indicated by an actual transcription of the comment (e.g., conversation bubbles 408), or description of the action. In one or more embodiments, the description of the action may be at least one of via text or pictures. For example, the first user 302 may post a question in the conversation panel 406 to begin the conversation and/or further describe the purpose of the collaboration. In the example shown herein, the first user 302 posts the question “Are the values being calculated correctly.” In one or more embodiments, an indicator may denote the source of the manipulation (e.g., which participant in the collaboration session the manipulation may be attributed to). Indicators may include, color, patterns, and any other suitable indicator. For example, all comments by the first user are in an orange conversation bubble.

Then in S222, a participant 302/304 manipulates the visualization 103. In one or more embodiments, manipulation of the visualization 103 may include selection of one of at least one element in the visualization and the entire visualization for annotation (e.g., add comments/markings to the visualization itself) at least one of visually and auditorily. In one or more embodiments, manipulation of the visualization may include adding comments in the conversation panel 406. The manipulation may be recorded in S224, and the manipulation may be associated with the participant making the manipulation in S226 (e.g., manipulation source). In one or more embodiments, the recordation may be displayed in the conversation panel 406. Continuing with the example shown in FIG. 4, the collaborator 304 may annotate the April 2012 date in Asset 35, as indicated by the dashed circle 410. Further, this manipulation may be associated with the collaborator 304, as indicated by the matching dashed circle around the collaborator's conversation bubble. In one or more embodiments, the conversation bubbles and/or associated manipulations may include a time/date of the manipulation.

In one or more embodiments, the CAE module 108 may allow the models to be re-run during the collaboration session 300, when they had been run during initiation of the collaboration session to generate data. The CAE module 108 may also allow the importation of input and other visualizations into the collaboration session 300. The imported input may be from other internal or external sources. A benefit of one or more embodiments may be that a participant may conduct some prior analysis (e.g., either input described above or imported input) on a local system, and then pull the input (e.g., data, code and results) into the collaboration session. For example, person A invites person B to the collaboration session, and after viewing the visualization, person B says, “I have this other data from another project I'm working on, and I think it's related.” Then person B imports the other data into the collaboration session. In one or more embodiments when the imported input is data, the data may be from at least one of a same time frame or about a same asset as the original visualization. During the collaboration session, the multiple inputs may be compared and discussed. In one or more embodiments, the collaboration session may include multiple visualizations about at least one input.

In one or more embodiments, the collaborator 304 may join the collaboration session in real time or “synchronously” or may join the collaboration session at a later time or “asynchronously.” In one or more embodiments, when the collaborator 304 joins the collaboration session, they may be presented with one of the visualization 103 as it was at the time the request to join the collaboration session was sent, or the visualization 103 as it exists at the time of their joining the collaboration session, or at any other suitable moment of the collaboration session. As used herein a “state of the visualization” may refer to when a participant has performed an action. For example, if person A highlights an aspect of the visualization and makes a related comment, and then person B joins the collaboration at some subsequent time, person B may select person A's comment, and then view the state of the visualization when person A made the comment. In one or more embodiments, a participant may filter the actions to see, for example, those executed by at least one of the participants, or on some other aspect. For example, a participant may want to see all of the scatter plots presented in the visualization where pl=5.

Turning to FIG. 5, a user interface 500 associated with the collaboration is provided in accordance with one or more embodiments. In one or more embodiments, when the collaboration session is initiated, as in S210, described above, the user interface 500 shown herein may be presented on the display to the first user 302. The user interface 500 may include a menu 502 with one or more selectable options 504 to guide the first user 302 in a set-up of the collaboration session. The selectable options 504 may include, but are not limited to, a digital twin dashboard, first asset (e.g., windfarm) performance, Get started, delve deeper, refine results, view results, build solution, load solution, complete tasks, solution done, second asset (e.g., solar) performance and templates dashboard. Other suitable selectable options 504 may be included. In one or more embodiments, the CAE module 308 may include a guide 506 to help the first user 302 set-up the collaboration session. The guide 506 may base the suggestions to the first user 302 on input from an Artificial Intelligence (AI) agent 128. For example, the AI agent 128 may make connections from the input that is used in past collaboration sessions, the visualizations and the recorded manipulations. The AI agent 128 may then make suggestions to the first user 302 or any other participant based on connections. In one or more embodiments, the AI agent 128 may extract metadata from past collaboration sessions and use it to provide guidance (e.g., offer suggestions) to participants on the content of the collaboration session and/or on participants to include in the collaboration session. In one or more embodiments, the AI agent 128 may text-mine the collaboration process (or use any other suitable knowledge extraction method) to create a common ontology, build a data store, and then access the data store at another time. For example, if a past collaboration session was about the temperature off of a jet engine, and the particular process that should occur when it goes about 3000 degrees, when a new collaboration session is being executed and a participant mentions a jet engine and/or temperature off a jet engine, the AI agent 128 may offer the data from the past collaboration session. With respect to the non-exhaustive example shown in FIG. 5, the AI agent 128 may ask the participant about the content of the collaboration session (e.g., “Tell me about your asset and what you are hoping to achieve”) 501. Then, based on the participant response 503, the AI agent 128 may one of ask further questions 505 in an effort to better align the guidance with the participant needs or provide results 507 that best match the participant needs. While in FIG. 5 the results 507 are provided in a different frame than the dialog between the AI agent 128 and the participant, in other embodiments, the results 507 and dialog may be in the same frame. In one or more embodiments, the participant may then select any of the results 507 for further analysis or may refine the results or search, for example. In one or more embodiments, the participant may select any of the results 507 as the input to be received in S212 or to be imported into the collaboration session. In one or more embodiments, the AI agent 128 may even recommend problems that may be asked and answered by the input at hand, and may recommend analytic algorithms, metrics, templates and best practices.

While the AI agent 128 is described herein with respect to guiding the first user 302 to set up the collaboration session, in one or more embodiments, the AI agent 128 may provide guidance during any portion of the collaboration session to any of the participants.

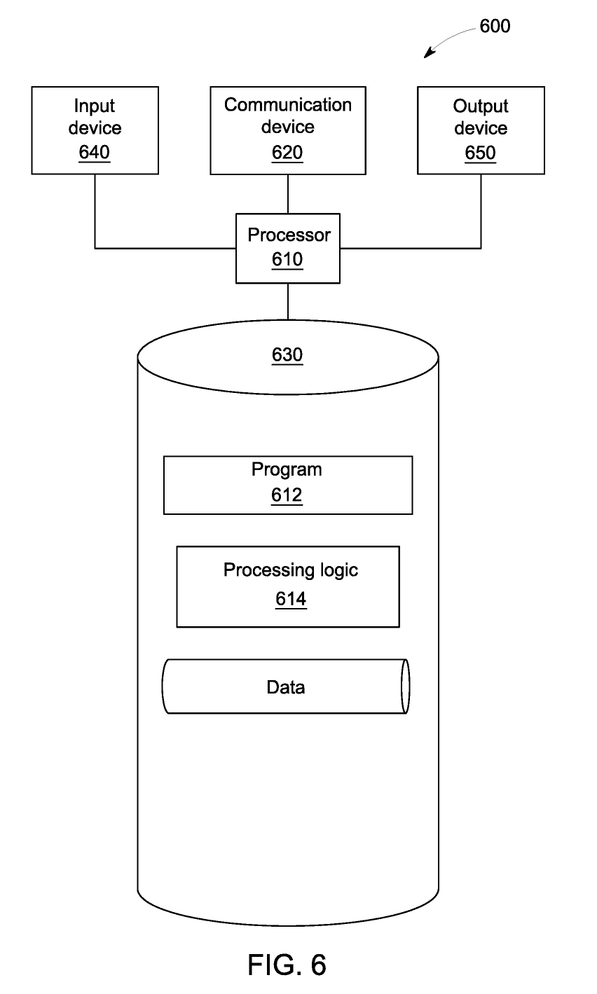

Note the embodiments described herein may be implemented using any number of different hardware configurations. For example, FIG. 6 illustrates a CAE platform 600 that may be, for example, associated with the system 100 of FIG. 1. The CAE platform 600 comprises a CAE processor 610 (“processor”), such as one or more commercially available Central Processing Units (CPUs) in the form of one-chip microprocessors, coupled to a communication device 620 configured to communicate via a communication network (not shown in FIG. 6). The communication device 620 may be used to communicate, for example, with one or more users. The CAE platform 600 further includes an input device 640 (e.g., a mouse and/or keyboard to enter information) and an output device 650 (e.g., to output and display the visualization/manipulations).

The processor 610 also communicates with a memory/storage device 630. The storage device 630 may comprise any appropriate information storage device, including combinations of magnetic storage devices (e.g., a hard disk drive), optical storage devices, mobile telephones, and/or semiconductor memory devices. The storage device 630 may store a program 612 and/or CAE processing logic 614 for controlling the processor 610. The processor 610 performs instructions of the programs 612, 614, and thereby operates in accordance with any of the embodiments described herein. For example, the processor 610 may receive data and then may apply the instructions of the programs 612, 614 to determine visualization and manipulation during a collaboration session.

The programs 612, 614 may be stored in a compressed, uncompiled and/or encrypted format. The programs 612, 614 may furthermore include other program elements, such as an operating system, a database management system, and/or device drivers used by the processor 610 to interface with peripheral devices.

As used herein, information may be “received” by or “transmitted” to, for example: (i) the platform 600 from another device; or (ii) a software application or module within the platform 600 from another software application, module, or any other source.

It is noted that while progress with industrial equipment automation has been made over the last several decades, and assets have become ‘smarter,’ the intelligence of any individual asset pales in comparison to intelligence that can be gained when multiple smart devices are connected together. Aggregating data collected from or about multiple assets may enable users to improve business processes, for example by improving effectiveness of asset maintenance or improving operational performance, if appropriate. Industrial-specific data collection and modeling technology may be developed and applied.

In an example, an industrial asset may be outfitted with one or more sensors configured to monitor respective ones of an asset's operations or conditions. Data from the one or more sensors may be recorded or transmitted to a cloud-based or other remote computing environment. By bringing such data into a cloud-based computing environment, new software applications informed by industrial process, tools and know-how may be constructed, and new physics-based analytics specific to an industrial environment may be created. Insights gained through analysis of such data may lead to enhanced asset designs, or to enhanced software algorithms for operating the same or similar asset at its edge, that is, at the extremes of its expected or available operating conditions.

The systems and methods for managing industrial assets may include or may be a portion of an Industrial Internet of Things (IIoT). In an example, an IIoT connects industrial assets, such as turbines, jet engines, and locomotives, to the Internet or cloud, or to each other in some meaningful way. The systems and methods described herein may include using a “cloud” or remote or distributed computing resource or service. The cloud may be used to receive, relay, transmit, store, analyze, or otherwise process information for or about one or more industrial assets. In an example, a cloud computing system may include at least one processor circuit, at least one database, and a plurality of users or assets that may be in data communication with the cloud computing system. The cloud computing system may further include, or may be coupled with, one or more other processor circuits or modules configured to perform a specific task, such as to perform tasks related to asset maintenance, analytics, data storage, security, or some other function.

However, the integration of industrial assets with the remote computing resources to enable the IIoT often presents technical challenges separate and distinct from the specific industry and from computer networks, generally. A given industrial asset may need to be configured with novel interfaces and communication protocols to send and receive data to and from distributed computing resources. Given industrial assets may have strict requirements for cost, weight, security, performance, signal interference, and the like, such that enabling such an interface is rarely as simple as combining the industrial asset with a general purpose computing device.

To address these problems and other problems resulting from the intersection of certain industrial fields and the IIoT, embodiments may enable improved interfaces, techniques, protocols, and algorithms for facilitating communication with, and configuration of, industrial assets via remote computing platforms and frameworks. Improvements in this regard may relate to both improvements that address particular challenges related to particular industrial assets (e.g., improved aircraft engines, wind turbines, locomotives, medical imaging equipment) that address particular problems related to use of these industrial assets with these remote computing platforms and frameworks, and also improvements that address challenges related to operation of the platform itself to provide improved mechanisms for configuration, analytics, and remote management of industrial assets.

The Predix™ platform available from GE is a novel embodiment of such Asset Performance Management Platform (APM) technology enabled by state of the art cutting edge tools and cloud computing techniques that may enable incorporation of a manufacturer's asset knowledge with a set of development tools and best practices that may enable asset users to bridge gaps between software and operations to enhance capabilities, foster innovation, and ultimately provide economic value. Through the use of such a system, a manufacturer of industrial assets can be uniquely situated to leverage its understanding of industrial assets themselves, models of such assets, and industrial operations or applications of such assets, to create new value for industrial customers through asset insights.

The further advancement in sensing, control, simulation and optimization in systems such as the disclosed extends past the current art APM limitations of past operations=future operations and little ability to trade off actions in maintenance or operations in the current period for those of future periods where optimal interventions may be made such as maintenance, assignment, duty limitations, through time, having the benefit of far more accurate starting conditions afforded by the true-up.

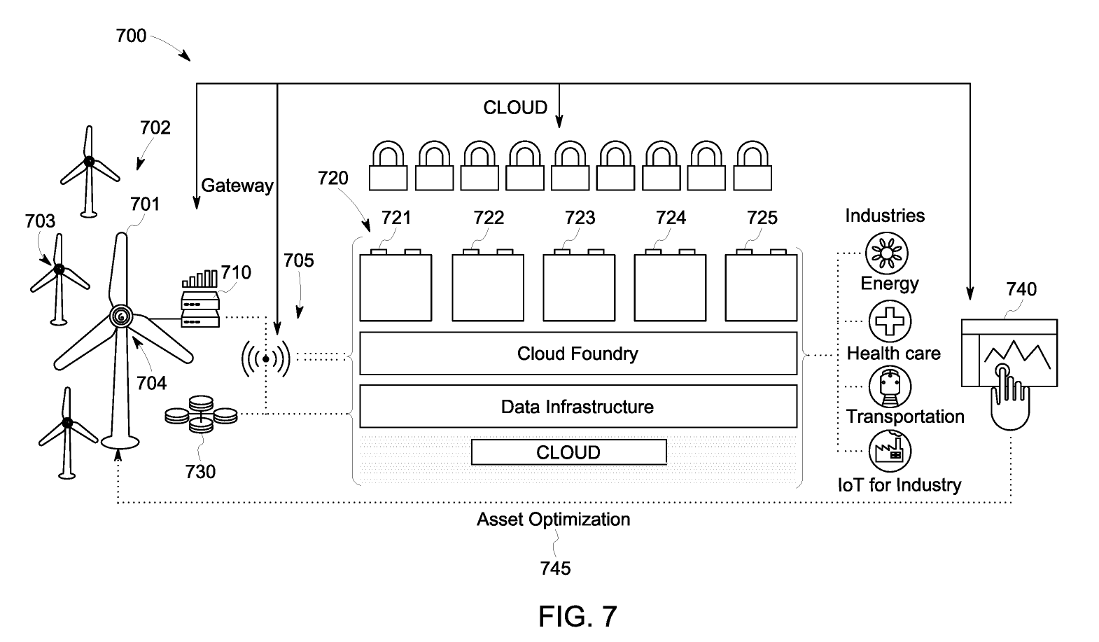

FIG. 7 illustrates generally an example of portions of a first APM 700. As further described herein, one or more portions of an APM may reside in an asset cloud computing system 720, in a local or sandboxed environment, or may be distributed across multiple locations or devices. An APM may be configured to perform any one or more of data acquisition, data analysis, or data exchange with local or remote assets, or with other task-specific processing devices.

The first APM 700 may include a first asset community 702 that may be communicatively coupled with the asset cloud computing system 720. A plurality of assets 702, 703 may be subject to state estimation at one or more multiple time intervals. Within a given industrial system, there may be estimations of state for more than one system or sub-system such as a blade of a wind turbine 701 or gear 704 associated with the turbine 701. These sub-systems may be combined to estimate the state of damage and performance for an integrated system such as, for example, a windmill, an aircraft engine, a power plant and a train. Other suitable integrated systems may be used. In an example, a machine module 710 receives information from, or senses information about, at least one asset member of the first asset community 702, and configures the received information for exchange with the asset cloud computing system 720. In an example, the machine module 710 is coupled to the asset cloud computing system 720 or to an enterprise computing system 730 via a communication gateway 705.

In an example, the communication gateway 705 includes or uses a wired or wireless communication channel that may extend at least from the machine module 710 to the asset cloud computing system 720. The asset cloud computing system 720 includes several layers. In an example, the asset cloud computing system 720 includes at least a data infrastructure layer, a cloud foundry layer, and modules for providing various functions. In the example of FIG. 7, the asset cloud computing system 720 includes an asset module 721, an analytics module 722, a data acquisition module 723, a data security module 724, and an operations module 725. Each of the modules 721-725 includes or uses a dedicated circuit, or instructions for operating a general purpose processor circuit, to perform the respective functions. In an example, the modules 721-725 are communicatively coupled in the asset cloud computing system 720 such that information from one module may be shared with another. In an example, the modules 721-725 are co-located at a designated datacenter or other facility, or the modules 721-725 can be distributed across multiple different locations.

An interface device 740 may be configured for data communication with one or more of the machine module 710, the gateway 705, or the asset cloud computing system 720. The interface device 740 may be used to monitor or control one or more assets. In an example, information about the first asset community 702 is presented to an operator at the interface device 740. The information about the first asset community 702 may include information from the machine module 710, or the information may include information from the asset cloud computing system 720. In an example, the information from the asset cloud computing system 720 may include information about the first asset community 702 in the context of multiple other similar or dissimilar assets, and the interface device 740 may include options for optimizing one or more members of the first asset community 702 based on analytics performed at the asset cloud computing system 720.

In an example, an operator selects a parameter update for the first wind turbine 701 using the interface device 740, and the parameter update is pushed to the first wind turbine via one or more of the asset cloud computing system 720, the gateway 705, and the machine module 710. In an example, the interface device 740 is in data communication with the enterprise computing system 730 and the interface device 740 provides an operation with enterprise-wide data about the first asset community 702 in the context of other business or process data. For example, choices with respect to asset optimization 745 may be presented to an operator in the context of available or forecasted raw material supplies or fuel costs. In an example, choices with respect to asset optimization 745 may be presented to an operator in the context of a process flow to identify how efficiency gains or losses at one asset may impact other assets. In an example, one or more choices described herein as being presented to a user or operator may alternatively be made automatically by a processor circuit according to earlier-specified or programmed operational parameters. In an example, the processor circuit may be located at one or more of the interface device 740, the asset cloud computing system 720, the enterprise computing system 730, or elsewhere.

Returning again to the example of FIG. 7 some capabilities of the first APM 700 are illustrated. The example of FIG. 7 includes the first asset community 702 with multiple wind turbine assets, including the first wind turbine 701. Wind turbines are used in some examples herein as non-limiting examples of a type of industrial asset that can be a part of, or in data communication with, the first AMP 700.

In an example, the multiple turbine members of the asset community 702 include assets from different manufacturers or vintages. The multiple turbine members of the asset community 702 may belong to one or more different asset communities, and the asset communities may be located locally or remotely from one another. For example, the members of the asset community 702 may be co-located on a single wind farm, or the members may be geographically distributed across multiple different farms. In an example, the multiple turbine members of the asset community 702 may be in use (or non-use) under similar or dissimilar environmental conditions, or may have one or more other common or distinguishing characteristics.

FIG. 7 further includes the device gateway 705 configured to couple the first asset community 702 to the asset cloud computing system 720. The device gateway 705 may further couple the asset cloud computing system 720 to one or more other assets or asset communities, to the enterprise computing system 730, or to one or more other devices. The first AMP 700 thus represents a scalable industrial solution that extends from a physical or virtual asset (e.g., the first wind turbine 701) to a remote asset cloud computing system 720. The asset cloud computing system 720 optionally includes a local, system, enterprise, or global computing infrastructure that can be optimized for industrial data workloads, secure data communication, and compliance with regulatory requirements.

In an example, information from an asset, about the asset, or sensed by an asset itself is communicated from the asset to the data acquisition module 724 in the asset cloud computing system 720. In an example, an external sensor may be used to sense information about a function of an asset, or to sense information about an environment condition at or near an asset. The external sensor may be configured for data communication with the device gateway 705 and the data acquisition module 724, and the asset cloud computing system 720 may be configured to use the sensor information in its analysis of one or more assets, such as using the analytics module 722.

In an example, the first AMP 700 may use the asset cloud computing system 720 to retrieve an operational model for the first wind turbine 701, such as using the asset module 721. The model may be stored locally in the asset cloud computing system 720, or the model may be stored at the enterprise computing system 730, or the model may be stored elsewhere. The asset cloud computing system 720 may use the analytics module 722 to apply information received about the first wind turbine 701 or its operating conditions (e.g., received via the device gateway 705) to or with the retrieved operational model. Using a result from the analytics module 722, the operational model may optionally be updated, such as for subsequent use in optimizing the first wind turbine 701 or one or more other assets, such as one or more assets in the same or different asset community. For example, information about the first wind turbine 701 may be analyzed at the asset cloud computing system 720 to inform selection of an operating parameter for a remotely located second wind turbine that belongs to a different second asset community.

The first AMP 700 includes a machine module 710. The machine module 710 may include a software layer configured for communication with one or more industrial assets and the asset cloud computing system 720. In an example, the machine module 710 may be configured to run an application locally at an asset, such as at the first wind turbine 701. The machine module 710 may be configured for use with, or installed on, gateways, industrial controllers, sensors, and other components. In an example, the machine module 710 includes a hardware circuit with a processor that is configured to execute software instructions to receive information about an asset, optionally process or apply the received information, and then selectively transmit the same or different information to the asset cloud computing system 720.

In an example, the asset cloud computing system 720 may include the operations module 725. The operations module 725 may include services that developers may use to build or test Industrial Internet applications, or the operations module 725 may include services to implement Industrial Internet applications, such as in coordination with one or more other AMP modules. In an example, the operations module 725 includes a microservices marketplace where developers may publish their services and/or retrieve services from third parties. The operations module 725 can include a development framework for communicating with various available services or modules. The development framework may offer developers a consistent look and feel and a contextual user experience in web or mobile applications.

In an example, an AMP may further include a connectivity module. The connectivity module may optionally be used where a direct connection to the cloud is unavailable. For example, a connectivity module may be used to enable data communication between one or more assets and the cloud using a virtual network of wired (e.g., fixed-line electrical, optical, or other) or wireless (e.g., cellular, satellite, or other) communication channels. In an example, a connectivity module forms at least a portion of the gateway 705 between the machine module 710 and the asset cloud computing system 720.

In an example, an AMP may be configured to aid in optimizing operations or preparing or executing predictive maintenance for industrial assets. An AMP may leverage multiple platform components to predict problem conditions and conduct preventative maintenance, thereby reducing unplanned downtimes in the near term or through time by intentional intervention. In an example, the machine module 710 is configured to receive or monitor data collected from one or more asset sensors and, using physics-based analytics (e.g., finite element analysis or some other technique selected in accordance with the asset being analyzed), detect error conditions based on a model of the corresponding asset. In an example, a processor circuit applies analytics or algorithms at the machine module 710 or at the asset cloud computing system 720, one embodiment having the analytic being a discrete event simulator which changes the exogenous conditions (e.g. weather) and control points, maintenance events, work-scopes and locations, runs replications and computes confidence intervals and contribution to variance over one or more time intervals. In another embodiment, the analytic being a dynamic programming modality. In another embodiment, the analytic being a Monte-Carlo modality.

In response to the detected error conditions, the AMP may issue various mitigating commands to the asset, such as via the machine module 710, for manual or automatic implementation at the asset. In an example, the AMP may provide a shut-down command to the asset in response to a detected error condition. Shutting down an asset before an error condition becomes fatal may help to mitigate potential losses or to reduce damage to the asset or its surroundings. In addition to such an edge-level application, the machine module 710 may communicate asset information to the asset cloud computing system 720.

In an example, the asset cloud computing system 720 may store or retrieve operational data for multiple similar assets. Over time, data scientists or machine learning may identify patterns and, based on the patterns, may create improved physics-based analytical models for identifying or mitigating issues at a particular asset or asset type. The improved analytics may be pushed back to all or a subset of the assets, such as via multiple respective machine modules 710, to effectively and efficiently improve performance of designated (e.g., similarly-situated) assets.

In an example, the asset cloud computing system 720 includes a Software-Defined Infrastructure (SDI) that serves as an abstraction layer above any specified hardware, such as to enable a data center to evolve over time with minimal disruption to overlying applications. The SDI enables a shared infrastructure with policy-based provisioning to facilitate dynamic automation, and enables SLA mappings to underlying infrastructure. This configuration may be useful when an application requires an underlying hardware configuration. The provisioning management and pooling of resources may be done at a granular level, thus allowing optimal resource allocation.

In a further example, the asset cloud computing system 720 is based on Cloud Foundry (CF), an open source PaaS that supports multiple developer frameworks and an ecosystem of application services. Cloud Foundry can make it faster and easier for application developers to build, test, deploy, and scale applications. Developers thus gain access to the vibrant CF ecosystem and an ever-growing library of CF services. Additionally, because it is open source, CF can be customized for IIoT workloads.

The asset cloud computing system 720 may include a data services module that may facilitate application development. For example, the data services module may enable developers to bring data into the asset cloud computing system 720 and to make such data available for various applications, such as applications that execute at the cloud, at a machine module, or at an asset or other location. In an example, the data services module may be configured to cleanse, merge, or map data before ultimately storing it in an appropriate data store, for example, at the asset cloud computing system 720. A special emphasis has been placed on time series data, as it is the data format that most sensors use.

Security may be a concern for data services that deal in data exchange between the asset cloud computing system 720 and one or more assets or other components. Some options for securing data transmissions include using Virtual Private Networks (VPN) or an SSL/TLS model. In an example, the first AMP 700 may support two-way TLS, such as between a machine module and the security module 724. In an example, two-way TLS may not be supported, and the security module 724 may treat client devices as OAuth users. For example, the security module 724 may allow enrollment of an asset (or other device) as an OAuth client and transparently use OAuth access tokens to send data to protected endpoints.

A plurality of assets 702, 703 may be subject to state estimation at one or multiple time intervals. Within a given industrial system, there may be estimations of state for more than one system or sub-system such as the blade 701 or the gear 704. These subsystems may be combined to estimate the state of damage and performance for an integrated system such as a windmill or aircraft engine or power plant or train.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors 610 (FIG. 6). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

1. A system comprising:
a collaboration analytic module;
a display;
a memory storing processor-executable process steps; and
a collaboration analytic processor coupled to the memory, and in communication with the collaboration analytic module and operative to execute the processor-executable process steps to cause the system to:
initiate a collaboration session;
receive input at the collaboration session, wherein the collaboration session is integrated with a source of the received input;
generate a visualization based on the received input;
receive selection from a user of at least one collaborator to participate in the collaboration session;
present the visualization on the display, wherein the visualization is viewable by the user and at least one collaborator;
receive a manipulation of the visualization;
record the manipulation of the visualization; and
associate the recorded manipulation with a manipulation source.

2. The system of claim 1, wherein the input source is an analytic computing platform.

3. The system of claim 1, wherein the input is at least one of data, an analytic model, and program code.

4. The system of claim 1, further comprising processor executable process steps to cause the system to:
execute an analytic prior to receiving data at the collaboration session.

5. The system of claim 4, wherein execution of the analytic further comprises processor executable process steps to cause the system to:
receive a selection of data;
receive one of a model and a selection of an existing model; and
execute one of the model and the existing model using the selected data.

6. The system of claim 1, wherein the collaboration session is initiated by the first user.

7. The system of claim 1, wherein manipulation of the visualization further comprises annotation of the input at least one of visually and auditorily.

8. The system of claim 1, further comprising processor executable process steps to cause the system to:
display, on the visualization, the source of the recorded manipulation.

9. The system of claim 1, wherein manipulation of the visualization further comprises processor executable process steps to cause the system to:
receive selection of an element on the visualization for manipulation.

10. The system of claim 9, wherein the element is at least one of a field, a region, and a row of a table.

11. The system of claim 1, further comprising processor executable process steps to cause the system to:
receive a second input in the collaboration session.

12. The system of claim 1, wherein the manipulation source is one of the first user and at least one collaborator.

13. A computer-implemented method comprising:
initiating a collaboration session;
receiving input at the collaboration session, wherein the collaboration session is integrated with a source of the received input;
generating a visualization based on the received input;
receiving selection from a user of at least one collaborator to participate in the collaboration session;
presenting the visualization on the display, wherein the visualization is viewable by the user and at least one collaborator;
receiving a manipulation of the visualization;
recording the manipulation of the visualization; and
associating the recorded manipulation with a manipulation source.

14. The method of claim 13, wherein the input source is an analytic computing platform.

15. The method of claim 13, wherein the input is at least one of data, an analytic model and program code.

16. The method of claim 13, further comprising:
executing an analytic prior to receiving data at the collaboration session.

17. The method of claim 16, wherein executing of the analytic further comprises:
receiving a selection of data;
receiving one of a model and a selection of an existing model; and
executing one of the model and the existing model using the selected data.

18. The method of claim 13, wherein the collaboration session is initiated by the first user.

19. The method of claim 13, wherein manipulation of the visualization further comprises:
annotating the input at least one of visually and auditorily.

20. The method of claim 13, further comprising:
displaying, on the visualization, the source of the recorded manipulation.

21. The method of claim 13, wherein manipulation of the visualization further comprises:
receiving selection of an element on the visualization for manipulation.

22. The method of claim 21, wherein the element is at least one of a field, a region, and a row of a table.

23. The method of claim 13, further comprising:
receiving a second input in the collaboration session

24. A non-transitory computer-readable medium storing program code, the program code executable by a computer system to cause the computer system to:
initiate a collaboration session;
receive input at the collaboration session, wherein the collaboration session is integrated with a source of the received input;
generate a visualization based on the received input;
receive selection from a user of at least one collaborator to participate in the collaboration session;
present the data in a visualization on the display, wherein the visualization is viewable by the user and at least one collaborator;
receive a manipulation of the visualization;
record the manipulation of the visualization; and
associate the recorded manipulation with a manipulation source.

25. The medium of claim 24, wherein the input source is an analytic computing platform.

26. The medium of claim 21, wherein the input is at least one of data, an analytic model and program code.

27. The medium of claim 24, wherein the collaboration session is initiated by the first user.

28. The medium of claim 24, wherein manipulation of the visualization further comprises annotation of the input at least one of visually and auditorily.

29. The medium of claim 28, further comprising program code executable by the computer system to cause the computer system to:
display, on the visualization, the source of the recorded manipulation.

30. The medium of claim 24 wherein manipulation of the visualization further comprises processor executable process steps to cause the system to:
receive selection of an element on the visualization for manipulation.
